(19) United States
(12) Patent Application Publication
(10) Pub. No.: US 2024/0180058 A1
(43) Pub. Date: Jun. 6, 2024

(54) 360 PLANT IMAGE CAPTURING SYSTEM AND RELATED METHODS

(71) Applicant: SOUTH DAKOTA BOARD OF REGENTS, Pierre, SD (US)

(72) Inventors: Ali Mirzakhani Nafchi, Brookings, SD (US); Ahmed Abdalla, Brookings, SD (US); Babak Azad, Brookings, SD (US)

(21) Appl. No.: 18/528,161

(22) Filed: Dec. 4, 2023

Related U.S. Application Data
(60) Provisional application No. 63/385,893, filed on Dec. 2, 2022.

(51) Int. Cl. A01B 76/00; F16M 11/04; F16M 11/08; F16M 11/42; G03B 17/18

(52) U.S. Cl. CPC A01B 76/00; F16M 11/046; F16M 11/08; F16M 11/42; G03B 17/18

(57) ABSTRACT

A system for monitoring plant or soil characteristics in a crop field, the system comprising a prime mover comprising a base and a camera frame operably coupled to the base. The camera frame comprises a central frame, a rotatable frame rotatably attached to the central frame, at least one camera attached to the rotatable frame.

### CROSS-REFERENCE TO RELATED APPLICATION(S)

This application claims the benefit under 35 U.S.C. § 119(e) to U.S. Provisional Application 63/385,893, filed Dec. 2, 2022, and entitled “360 Plant Image Capturing System and Related Methods,” which is hereby incorporated herein by reference in its entirety.

### GOVERNMENT SUPPORT

This invention was made with government support under Grant No. SA2200276, awarded by the Agricultural Research Service of the U.S. Department of Agriculture. The government has certain rights in the invention.

### FIELD

The various embodiments herein relate to systems for monitoring plant and/or soil characteristics in a crop field. More specifically, the embodiments herein relate to systems that monitor plant and/or soil characteristics using cameras with pan and/or tilt capabilities.

### BACKGROUND

Various known systems for capturing images of plants—especially in a field environment—are used to identify different types of plants for operations such as spot spraying and the like. One such system is the Mineral project that has been created by X company (https://x.company/projects/mineral/). One of the disadvantages of such systems is that they typically utilize a single fixed camera per crop row to capture images of the plants in that row. This results in low resolution and lack of detailed information such that such systems have about a 10-20% accuracy in identifying plants and/or various target characteristics thereof.

There is a need in the art for an improved image capturing system for plants in a field environment.

### BRIEF SUMMARY

Discussed herein are various systems for monitoring plant and/or soil characteristics in a crop field.

In Example 1, a system for monitoring plant or soil characteristics in a crop field comprises a prime mover comprising a base and a camera frame operably coupled to the base. The camera frame comprises a central frame, a rotatable frame rotatably attached to the central frame, at least one camera attached to the rotatable frame.

Example 2 relates to the system for monitoring plant or soil characteristics in a crop field according to Example 1, wherein the at least one camera is rotatable in relation to the prime mover.

Example 3 relates to the system for monitoring plant or soil characteristics in a crop field according to Example 2, wherein the camera frame is rotatable in relation to the prime mover.

Example 4 relates to the system for monitoring plant or soil characteristics in a crop field according to Example 1, wherein the camera frame further comprises a rotation actuator.

Example 5 relates to the system for monitoring plant or soil characteristics in a crop field according to Example 1, wherein the camera frame is a disk or an arm.

Example 6 relates to the system for monitoring plant or soil characteristics in a crop field according to Example 1, wherein the at least one camera is angularly movable.

Example 7 relates to the system for monitoring plant or soil characteristics in a crop field according to Example 6, wherein the camera frame comprises an angular adjustment actuator configured to angularly move the at least one camera.

Example 8 relates to the system for monitoring plant or soil characteristics in a crop field according to Example 1, further comprising a height adjustment mechanism coupled to the base and the camera frame.

Example 9 relates to the system for monitoring plant or soil characteristics in a crop field according to Example 8, wherein the height adjustment mechanism further comprises an actuator and a height sensor, wherein the height sensor is configured to track a position of the camera frame, and wherein the actuator is configured to change a height of the camera frame.

Example 10 relates to the system for monitoring plant or soil characteristics in a crop field according to Example 1, wherein the prime mover comprises a structure selected from a group consisting of a drone, at least four wheels, and at least one track.

Example 11 relates to the system for monitoring plant or soil characteristics in a crop field according to Example 1, wherein the at least one camera is configured to rotate up to about 360 degrees about an axis.

In Example 12, a system for monitoring plant or soil characteristics in a crop field comprises a prime mover comprising at least four wheels and a horizontal bar, a height adjustment mechanism coupled to the horizontal bar, and a non-rotatable camera frame operably coupled to the height adjustment mechanism, the non-rotatable camera frame comprising at least two cameras attached to the non-rotatable camera frame.

Example 13 relates to the system for monitoring plant or soil characteristics in a crop field according to Example 12, wherein the non-rotatable camera frame is a disk.

Example 14 relates to the system for monitoring plant or soil characteristics in a crop field according to Example 12, wherein the height adjustment mechanism further comprises an actuator and a height sensor, wherein the height sensor is configured to track a position of the non-rotatable camera frame, and wherein the actuator is configured to change a height of the non-rotatable camera frame.

In Example 15, a system for monitoring plant or soil characteristics in a crop field comprises a prime mover comprising a base, a height adjustment mechanism coupled to the base comprising a height adjustment actuator and a height sensor, and at least one camera frame operably coupled to the height adjustment mechanism. The at least one camera frame comprises a central frame, a rotatable frame rotatably attached to the central frame, a rotatable frame actuator configured to rotatably move the rotatable frame relative the central frame, a rotation sensor configured to track a rotation speed of the rotatable frame, and at least one camera attached to the rotatable frame. The height sensor is configured to sense a height of the at least one camera frame and the height adjustment actuator is configured to change the height of the at least one camera frame.

Example 16 relates to the system for monitoring plant or soil characteristics in a crop field according to Example 15, wherein each camera comprises a downward angular position relative the rotatable frame ranging from about 30 degrees to about 60 degrees.

Example 17 relates to the system for monitoring plant or soil characteristics in a crop field according to Example 15, wherein the rotatable frame actuator comprises a motor gear rotatably coupled to the rotatable frame.

Example 18 relates to the system for monitoring plant or soil characteristics in a crop field according to Example 15, wherein the at least one camera frame is configured to rotate 360 degrees.

Example 19 relates to the system for monitoring plant or soil characteristics in a crop field according to Example 15, wherein the at least one camera frame can rotate from about 0.1 rpm to about 100 rpm.

Example 20 relates to the system for monitoring plant or soil characteristics in a crop field according to Example 15, wherein the prime mover comprises a speed wheel configured to track a ground speed of the prime mover, the speed wheel being in communication with the rotation sensor, the rotation sensor being configured to change the rotation speed in response to the ground speed.

While multiple embodiments are disclosed, still other embodiments will become apparent to those skilled in the art from the following detailed description, which shows and describes illustrative embodiments. As will be realized, the various implementations are capable of modifications in various obvious aspects, all without departing from the spirit and scope thereof. Accordingly, the drawings and detailed description are to be regarded as illustrative in nature and not restrictive.

### BRIEF DESCRIPTION OF THE DRAWINGS

FIG. 1 is a perspective view of a system for monitoring plant or soil characteristics, according to one embodiment.

FIG. 2 is a perspective view of a rotatable disk of a system for monitoring plant or soil characteristics, according to one embodiment.

FIG. 3 is a perspective view of an adjustment mechanism of a system for monitoring plant or soil characteristics, according to one embodiment.

FIG. 4 is a perspective view of a system for monitoring plant or soil characteristics, according to one embodiment.

FIG. 5A is a perspective view of a system for monitoring plant or soil characteristics, according to one embodiment.

FIG. 5B is a perspective view of a rotatable disk of a system for monitoring plant or soil characteristics, according to one embodiment.

FIG. 6 is a block diagram illustrating a computing device configured to perform the techniques described herein, according to one embodiment.

FIG. 7 is a flowchart illustrating a technique of processing information described herein, according to one embodiment.

FIG. 8A is a perspective view of a system for monitoring plant or soil characteristics, according to one embodiment.

FIG. 8B is a front view of a system for monitoring plant or soil characteristics, according to one embodiment.

FIG. 9A is a front view of a camera assembly of a system for monitoring plant or soil characteristics, according to one embodiment.

FIG. 9B is a perspective view of a camera assembly of a system for monitoring plant or soil characteristics, according to one embodiment.

FIG. 9C is a front view of a camera assembly of a system for monitoring plant or soil characteristics, according to one embodiment.

FIG. 9D is a front view of a camera of a system for monitoring plant or soil characteristics, according to one embodiment.

FIG. 10A is an expanded view of a portion of a camera assembly of a system for monitoring plant or soil characteristics, according to one embodiment.

FIG. 10B is an expanded view of the actuators of a camera assembly of a system for monitoring plant or soil characteristics, according to one embodiment.

FIG. 11 is a perspective view of a camera assembly of a system for monitoring plant or soil characteristics, according to one embodiment.

FIG. 12 is a cross-sectional view of a system for monitoring plant or soil characteristics, according to one embodiment.

FIG. 13 is a perspective view of a system for monitoring plant or soil characteristics, according to one embodiment.

FIG. 14 is a perspective view of a camera assembly of a system for monitoring plant or soil characteristics, according to one embodiment.

FIG. 15A is a perspective view of a system for monitoring plant or soil characteristics, according to one embodiment.

FIG. 15B is a bottom view of a system for monitoring plant or soil characteristics, according to one embodiment.

FIG. 15C is a perspective view of a system for monitoring plant or soil characteristics, according to one embodiment.

FIG. 16A is a perspective view of a system for monitoring plant or soil characteristics, according to one embodiment.

FIG. 16B is a perspective view of a camera assembly of a system for monitoring plant or soil characteristics, according to one embodiment.

### DETAILED DESCRIPTION

The various embodiments herein relate to a plant scanning and image capturing systems for use in various outdoor environments, including, for example, row crop fields. Certain implementations include such a system that is incorporated into a prime mover (such as a manually controlled or autonomously controlled machine, including both ground-based prime movers and flying prime movers) or a farm implement (such as a crop sprayer, cultivator, or the like).

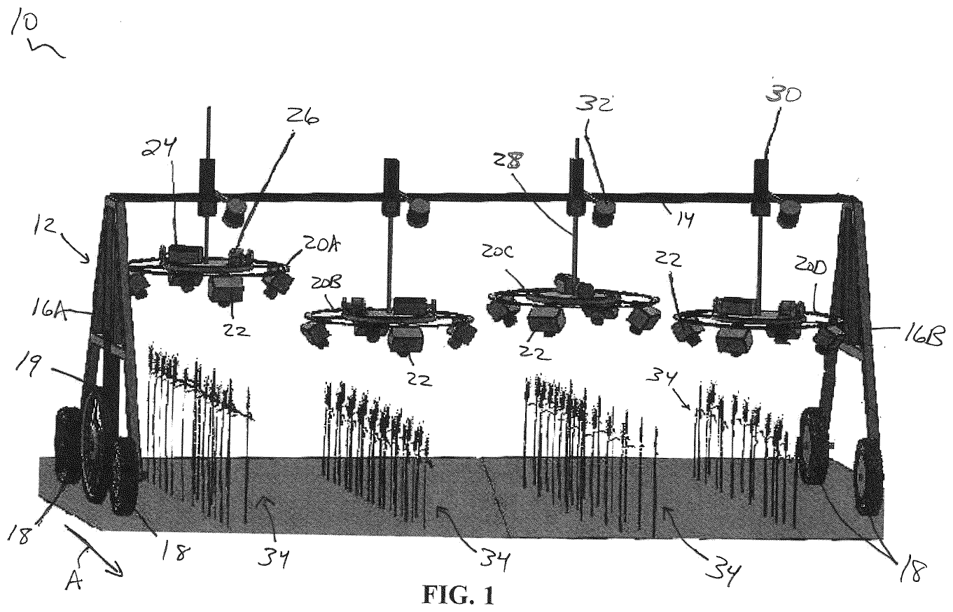

One specific implementation of a plant scanning and image capturing system 10 is depicted in FIG. 1, in which the system 10 is a self-propelled ground-based prime mover 10 having a frame 12 with a horizontal bar 14, two support frames 16A, 16B (with one disposed at each end of the bar 14), and four wheels 18 attached to the support frames 16A, 16B as shown. In addition, the frame 12 also has a speed measurement wheel 19 rotatable attached to the vertical support frame 16A as shown. In this exemplary embodiment as shown, the system 10 has four rotatable camera frames (or “disks”) 20A, 20B, 20C, 20D, attached to the horizontal bar 14, with each rotatable frame 20A-D having four cameras 22 disposed thereon. Each disk 20A-20D also has a motor 24 or other actuator to cause rotation of the disk 20A-20D as will be described in additional detail below, along with a position or rotation sensor 26 to track the rotational position of the disk 20A-20D (and thus the cameras 22 on the disk 20A-20D) as it rotates.

Each disk 20A-20D is attached to the bar 14 via a vertical rod 28. More specifically, each rod 28 is movably coupled to the bar 14 via a vertical adjustment assembly 30 such that the assembly 30 can move the rod 28 vertically in relation to the assembly 30 and the bar 14, thereby allowing for vertical adjustment of each disk 20A-20D as desired. In certain embodiments, each vertical adjustment assembly 30 has a separate scanning mechanism 32 operably coupled thereto such that the scanning mechanism 32 can be used to gauge the height of the target row of crops and actuate the adjustment assembly 30 to adjust the vertical height of the coupled disk 20A-20D as desired. The vertical height can be the height of the disks above the ground. The vertical height of the disks 20A-20D can range from about 2 inches to about 180 inches. In other embodiments, the vertical height of the disks 20A-20D can be 100 inches.

In the specific embodiment as shown in FIG. 1, the system 10 has four rotatable disks 20A-20D such that the system 10 can capture images of four rows 34 of crop plants. Alternatively, the various system implementations disclosed or contemplated herein can have one, two, three, five, six, seven, eight, nine, ten, 11, 12, 13, 14, 15, 16, or any other number of rotatable disks 20A-20N to capture images of the corresponding number of crop rows 34 and the individual plants in those rows 34.

According to one embodiment, at least two of the wheels 18 are coupled to a motive force (not shown) such as a motor or an engine such that the wheels 18 are actuated by the motive force to rotate, thereby urging the system 10 across the field. In one embodiment, the forward direction of the system 10 is indicated by arrow A in FIG. 1. Alternatively, the system 10 can be urged in either direction. In further embodiments, instead of a frame like frame 12, the four disks 20A-20D (or any other number of disks) can be incorporated into a farm implement such as a sprayer, a cultivator, or any other implement that can be coupled to a prime mover such as a tractor. In further alternatives, the four disks 20A-20D (or any other number of disks) can be incorporated into a prime mover itself, including a manually operated prime mover similar to a tractor or a self-propelled sprayer. In yet another alternative, the system 10 as shown can be a prime mover that is an autonomous prime mover.

The speed measurement wheel 19 collects information about the ground speed of the system 10. In one embodiment, the wheel 19 is a free wheel encoder 19. Alternatively, the wheel 19 can be any ground speed measurement wheel or mechanism. In various alternatives, the wheel 19 can be disposed elsewhere on the frame 12, such as the other vertical support 16B or some other position. In a further alternative, one of the four wheels 18 can also serve as the speed measurement wheel.

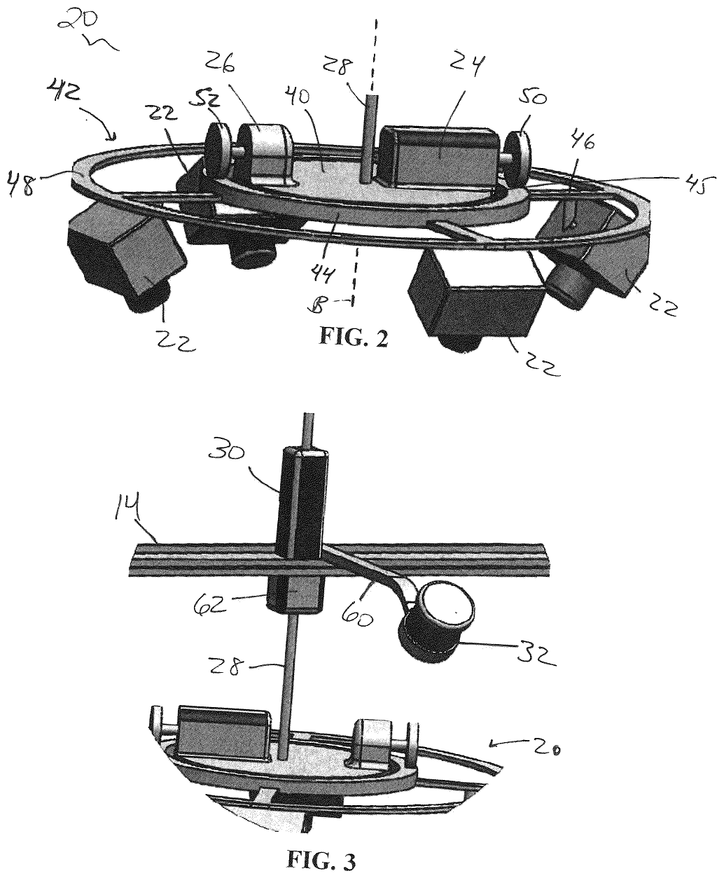

One exemplary rotatable disk 20 (representing any one or more of the disks 20A-D discussed above) is depicted in FIG. 2, according to one embodiment. The disk 20 has a fixed or central frame 40 fixedly attached to the vertical rod 28 and an outer frame 42 rotatably attached to the fixed frame 40. The outer frame 42 has an inner ring 44 and an outer ring 48 that is coupled to the inner ring 44 via radial arms 46 as shown. In addition, the disk 20 has four cameras 22 attached thereto, with each of the cameras attached to a separate one of the radial arms 46. The inner ring 44 defines an opening 45 within the inner ring 44 that is sized to receive the central frame 40 such that the central frame 40 is disposed within the opening 45 and the inner ring 44 (and entire outer frame 42) can rotate around the central frame 40. Thus, the outer rotatable frame 42 is disposed radially adjacent to the fixed frame 40 such that the rotatable outer frame 42 is rotatably coupled to fixed frame 40, thereby allowing for rotation of the four cameras 22 around the rotational axis of the disk 20, which is defined by the vertical rod 28 (that is, the rotational axis is co-axial with the axis of the vertical rod 28). In one embodiment, the rotational axis is represented by dotted line B in FIG. 2. As such, the outer edge of the fixed frame 40 is disposed adjacent to the inner edge of the inner ring 44 with the inner ring 44 rotatable around the fixed frame 40. Alternatively, the entire disk 20 can be a unitary component that rotates in relation to the vertical rod 28 (rather than an outer frame rotating in relation to a central frame). In a further alternative, the rotatable disk 20 can be configured in any way that allows for controlled rotation of the four cameras 22 attached thereto. Each outer ring 48 can have a diameter ranging from about 10 inches to about 120 inches. In other embodiments, the diameter can be about 100 inches.

In one embodiment, the disk actuator 24 causes the outer frame 42 to rotate in relation to the central frame 40. In the specific implementation as depicted in FIG. 2, the disk actuator 24 is fixedly attached to the central frame 40 and has a motor gear 50 that is rotatably coupled to the inner ring 44 of the outer frame 42. Thus, actuation of the actuator 24 causes rotation of the motor gear 50, which causes rotation of the inner ring 44, thereby causing rotation of the outer frame 42 in relation to the central frame 40 (and thereby causing rotation of the cameras 22 around the rotational axis B of the disk 20). In one example, the disk actuator 24 is a rotational motor such as a stepper motor. Alternatively, the disk actuator 24 can be any known actuator in any configuration that can cause the cameras to rotate as described herein.

In the implementation as shown in FIG. 2, the disk 20 has four cameras 22. Alternatively, the disk 20 can have one camera, two cameras, three cameras, five cameras, six cameras, seven cameras, eight cameras, nine cameras, ten cameras, or any number of cameras as desired. More specifically, in certain embodiments in which increased detail or accuracy is desired, a greater number of cameras (at least four, or at least six, for example) is included on each disk 20. Alternatively, in other implementations in which different types of cameras need to be attached to each disk 20 (to capture different information), that can influence the number of cameras 22 attached to each disk 20. In a further alternative, any number of factors can influence the number of cameras 22 attached to each disk 20.

Each camera 22 is attached to the disk 20 such that the lens is aimed at about a 45 degree angle (in relation to the ground) in order to capture images of both the top and side of each plant in the target row 34. Alternatively, each camera 22 can be attached the disk 20 such that the lens is aimed at an angle ranging from about 30 degrees to about 60 degrees. In a further implementation, the angle of either the camera 22 or the lens is adjustable such that the amount of the top and side of each plant that is captured by the field of view of the camera 22 can be adjusted, either manually or automatically.

In certain embodiments, all four (or any number) of the cameras 22 can be the same type of camera. More specifically, in certain embodiments, each camera 22 can be a hyperspectral, multispectral, or RGB camera. Alternatively, any or all of the cameras 22 can range from 400 or below to 2500 nm. In a further alternative, any one or more of the cameras 22 can be a camera that captures the high bands (such as the Mica Sense Red Edge-P Multispectral camera) and/or a hyperspectral camera that captures the narrow bands (such as the Meiji Techno HD9500M camera). In accordance with a further embodiment, one or more of the cameras 22 on each disk 20A-20D can be a different type of camera with different features and/or capabilities to detect a different characteristic, phenomenon, or point of interest on the target plants, soil, or other objects. For example, different types of cameras could be used to detect different plant diseases or plant characteristics. For example, in one exemplary implementation, one of the cameras 22 can be a hyperspectral camera such as the 80-channeled aerial Digital Airborne Imaging Spectrometer. Alternatively, any one of the cameras 22 can be a camera that captures a different spectrum of light, such as, for example, any camera or sensor that operates in the visible spectrum (VIS), any camera that operates in the near-infrared (NIR), any camera that operates in the shortwave-infrared (SWIR), and/or any 3D Lidar sensor. In a further alternative, one or more of the camera 22 can have a different lens to capture different characteristics. In further embodiments, the system 10 can have software to operate in conjunction with the cameras 22 having multiple lens options such that the software can select the appropriate lens and actuate the target camera(s) 22 to use that specific lens. In other words, any system 10 embodiment herein can have different cameras 22 and/or different lenses on each camera 22 to detect different plant characteristics, plant diseases, soil conditions, etc.

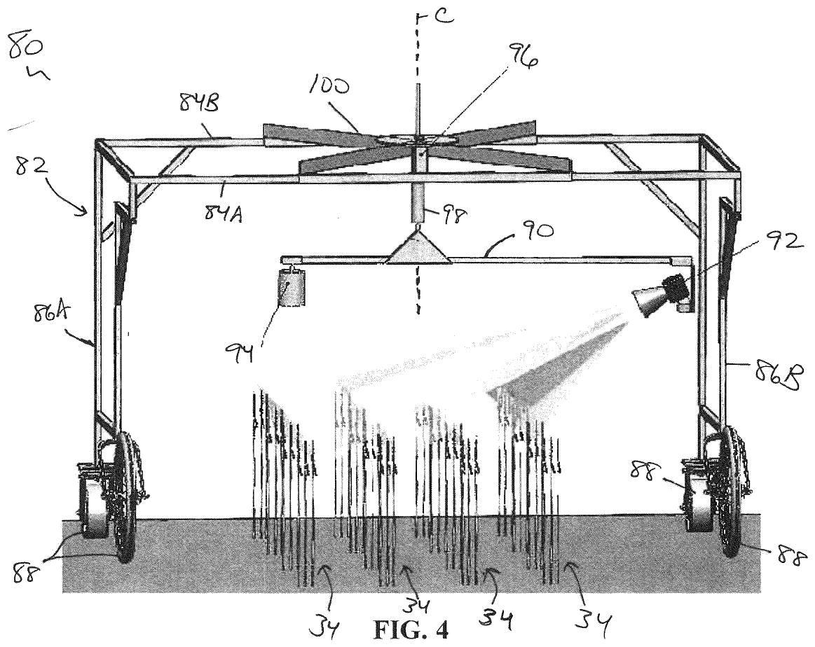

According to certain embodiments, as mentioned above, each vertical adjustment mechanism 30 has a vertical rod 28 (that is coupled to a disk 20) moveably coupled thereto such that the adjustment mechanism 30 can be used to urge the rod 28 in one direction or the other (“up” or “down,” according to one perspective). More specifically, as shown in FIG. 3, the adjustment mechanism 30 is fixedly attached to the horizontal bar 14 and has the vertical rod 28 disposed within or otherwise coupled to the adjustment mechanism 30. In certain implementations, the system 10 also has a position sensor 62 for tracking the position of the vertical rod 28 in relation to the adjustment mechanism 30 and/or horizontal bar 14. As such, the adjustment mechanism 30 is rotatably or otherwise movably coupled to the rod 28 such that the mechanism 30 can actuate the rod 28 to move in an axial direction (with the sensor 62 tracking the position of the rod 28). That is, the mechanism 30 has an actuator (such as a motor) (not shown) that is used to power the movement of the rod 28. Further, the adjustment mechanism 30 has a drive mechanism (not shown) coupled to the actuator and further coupled to the rod 28 in order to convert the power of the actuator into movement of the rod 28. For example, the mechanism can have gears (not shown) that are rotatably coupled to the rod 28. Alternatively, the adjustment mechanism 30 can be coupled to the rod 28 via any known mechanism that can be used to cause the rod 28 to move in an axial direction (either up or down) as discussed above. In one specific embodiment, the adjustment mechanism 30 is an actuator. Alternatively, the adjustment mechanism 30 can be any known mechanism or device of any configuration that can move the rod 28 up and down as described herein.

In some implementations, as also mentioned above, the system 10 can also have a separate scanning or sensing mechanism 32 for each of the adjustment mechanisms 30 such that each mechanism 30 has a scanning or sensing mechanism 32 coupled thereto. Thus, in those embodiments with four disks 20A-20D such as FIG. 1, each of the four adjustment mechanisms 30 has a scanning or sensing mechanism 32 coupled thereto. One such embodiment is depicted in further detail in FIG. 3, in which the scanning or sensing mechanism 32 is coupled to the bar 14 via an arm 60. More specifically, the arm 60 is coupled at one end to the bar 14 and further is coupled at the other end to the scanning/sensing mechanism 32. Further, the arm 60 and mechanism 32 are attached along the length of the bar 14 such that the arm 60, and thus the mechanism 32, are disposed adjacent to the adjustment mechanism 30 to which the scanning/sensing mechanism 32 is coupled.

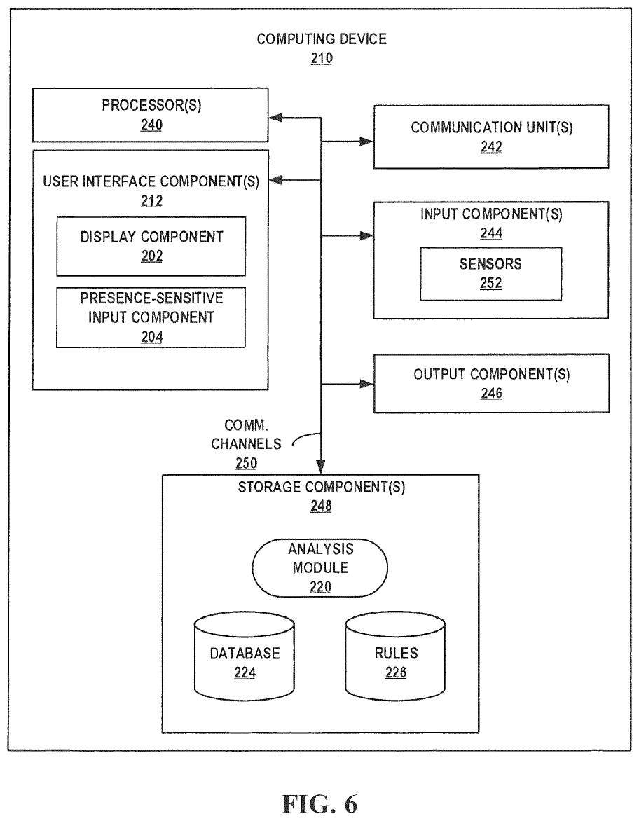

In certain embodiments, as best shown in FIGS. 1 and 3, each of the scanning/sensing mechanisms 32 is aimed at an angle in relation to the bar 14 such that the viewing area captured by the mechanism 32 includes several of the individual plants that the system 10 is approaching. More specifically, the scanning/sensing mechanism 32 can be aimed forward (in the same direction that the frame 12 is moving as indicated by arrow A) such that it captures at least two, and in some embodiments, at least four or six, plants in its target row 34 such that the mechanism 32 can gather data about the height of each of the plants in that row 34. From this information, the mechanism 32 or a processor coupled thereto (not shown) can calculate an average height of the predetermined number of forward positioned plants in the row 34. This height information can then be communicated to the coupled vertical adjustment mechanism 30 and sensor 62 such that the mechanism 30 is actuated to move the vertical rod 28 to place the coupled disk 20 (one of disks 20A-20D) at the optimal height in relation to the plants in the target row 34, thereby ensuring optimal capture of the desired images of each plant. An example of a computing device 210 that includes the processor 240 for such calculations is shown with respect to FIG. 6.

In one embodiment, the scanning/sensing mechanism 32 can be a LiDAR camera. For example, the LiDAR camera can be the Mobile LiDAR scanner (MLS), the Unmanned LiDAR scanner (ULS), the Velodyne-Puck 3D LiDAR that generates high quality perception in a wide variety of light conditions, or any other known LiDAR camera. Alternatively, the scanning/sensing mechanism 32 can be any known camera or scanning device that can be used to capture the appropriate height information relating to each plant in the target row as described above and further can obtain 3D structural plant shape information as well.

In use, the rotatable camera disks 20A-20D in system 10 (or any system embodiment as disclosed or contemplated herein) are able to capture images of separate plants from multiple angles around a full 360 degrees of each plant and in adjustable close proximity thereto. Together, the disk rotation and disk height adjustment allow the cameras 22 to collect detailed and accurate information about plant health, soil health, and other environmental conditions around each plant.

According to certain embodiments, the speed of the rotation of each of the rotatable disks 20A-20D can be precisely controlled to ensure accurate capture of the desired information about the plants and soil. More specifically, the position/rotation sensor 26 coupled to the rotation actuator 24 on each disk 20A-20D accurately tracks the exact position of the rotatable outer frame 42 and thus each camera 22 on the frame 42. As such, the position/rotation sensor 26 can operate in conjunction with the actuator 24 to position each camera 22 (or all four cameras 44 in certain embodiments) within the 360° of rotation to best capture the desired information. This precise camera location and rotation control improves the image analysis techniques and machine/deep learning processes of the system 10. In one embodiment, the position/rotation sensor 26 is a rotary encoder 26. Alternatively, any known position/rotation sensor 26 can be used.

Further, in some implementations, the disk 20A-20D height and thus camera 22 height can be precisely controlled to further ensure accurate capture of more detailed information about the plants and soil (more detailed in comparison to any camera with non-adjustable height). More specifically, the disk 20A-20D/camera 22 height and ground clearance can be adjusted in real-time via the vertical adjustment assembly 30 in combination with the scanning/sensing mechanism 32 (based on average plant height as discussed above) to optimize the focal point or field of view of the lens of each camera 22 on the disk 20A-20D in relation to each plant in the target crop row 34.

In addition, in certain systems 10, the disk 20A-20D rotation speed can also be controlled and adjusted to ensure optimal capture of the desired plant and/or soil images, in accordance with some embodiments. More specifically, the rotation speed of each disk 20A-20D can be adjusted based on the ground speed of the frame 12 such that the rotation speed of the disks 20A-20D is increased when the ground speed is increased and is decreased when the ground speed is decreased. In operation, the ground speed is tracked via the speed measurement wheel 19 as discussed above. The ground speed information is transmitted from the wheel 19 to the position/rotation sensor 26 (or directly to the rotation actuator 24) such that the rotational speed of the outer frame 42 can be controlled and/or adjusted based on the ground speed. Alternatively, or in addition, the rotation speed of each disk 20A-20D can be adjusted to optimize the desired level of detail to be captured by the cameras 22.

According to one embodiment, each disk 20A-20D can rotate at a speed ranging from about 0.1 rpm to about 100 rpm. Alternatively, the rotation speed can range from about 1 rpm to about 20 rpm. In some embodiments, the system 10 can use machine and/or deep learning techniques to adjust the disk rotation speed and the disk height to achieve an optimal image capture as described herein.

With respect to image capture and processing, in one embodiment, the system 10 can operate in the following manner. A first camera 22 of the one or more cameras 22 on the disk 20A-D can capture a first image while the first camera 22 is at a specific location in the 360 degree rotation of the disk 20A-20D. For purposes of this example, the location of the camera 22 will be designated as the 0° angle or position, and the image captured at the location will be transmitted to a processor (e.g., processors 240 of FIG. 6) and/or database (e.g., database 224 of FIG. 6) and saved to the database or other computer memory with a designation or “tag” of 1. Next, as the rotatable frame 42 (and thus the camera 22) rotates such that the camera 22 moves to a different position, a second image can be captured at the new position. For example, the camera 22 can be actuated to capture the second image at the 30° position and the second image can be transmitted to the processor with the “2” tag. This continues as the camera 22 rotates on the frame 42, with the camera 22 continuing to capture images at the desired intervals and each image tagged or otherwise identified with a consecutive number (tags 3, 4, etc.) or other designation is saved to the database or other computer memory.

In some implementations, the saved images can be transmitted wirelessly to a network-based computer (e.g., computing device 210 of FIG. 6) such that the images will be processed via a processor. The images can be processed separately or on a point cloud made from them and processed with deep 3D models. Such a deep 3D model can examine the images and segment the spots that contain the point(s) of interest from the rest of the images.

An alternative plant scanning and image capturing system 80 embodiment is depicted in FIG. 4, in which the system 80 is a self-propelled prime mover 80 having a frame 82 with horizontal bars 84A, 84B, two vertical support frames 86A, 86B (with one disposed at each end of the bars 84A, 84B), and four wheels 88 attached to the support frames 86A, 86B as shown. The various components and features of this system 80 are substantially similar to the corresponding components and features of the system 10 discussed above except as expressly discussed below.

In this exemplary embodiment as shown, the system 80 has one rotatable camera arm (or “boom”) 90 attached to the horizontal bars 84A, 84B, with the rotatable arm 90 having one camera 92 disposed thereon. The rotatable camera arm 90 can have a length from the vertical rod 98 to the end of the arm 90 ranging from about 20 inches to about 120 inches. In other embodiments, the rotatable arm 90 can have a length ranging from about 60 inches to about 80 inches. More specifically, in this particular implementation, the camera 92 is attached to one end of the arm 90 and a counterweight 94 is disposed at the other end to counter the weight of the camera 92. Alternatively, the rotatable arm 90, in certain implementations, can have no counterweight or, in a further alternative, can have any configuration that allows for rotation of a camera 92 as described herein. The rotatable arm 90 is rotatably coupled to an actuator 96 via a vertical rod 98 that extends from the actuator to the arm 90 as shown such that the arm 90 can rotate around the axis C represented by the dotted line C. In one embodiment, the actuator 96 is attached to the horizontal bars 84A, 84B via an X-frame 100. Alternatively, the actuator 96 can be coupled to the horizontal bars 84A, 84B via any known structure.

In use, except as expressly discussed below, the system 80 can use the single camera 92 to capture the images of the individual plants in each target row 34 in a fashion similar to the multiple cameras 22 in the system 10 as discussed above. And the image capture and processing can occur in a similar manner as well.

In the system 80 embodiments having a single camera 92, the images can be processed in a different manner than the system 10 above. More specifically, as the camera 92 rotates and captures images from multiple angles in the 360° rotation, the image segmentation (as part of the processing) can be used to separate out (and thus identify) each separate row and each separate plant within that row. This can be done based on the row and plant spacing, camera rotational position, camera lens angle, camera height, and plant height. Once the different plants are identified, the different plant characteristics can be identified as well.

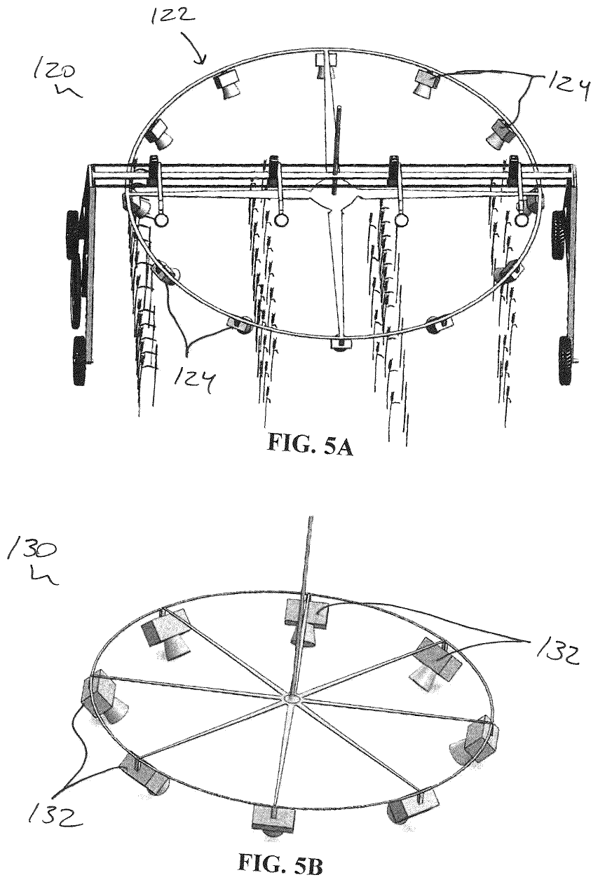

According to another embodiment as shown in FIGS. 5A and 5B, a system 120 is provided that has a single non-rotating disk or frame 122 attached thereto. The various components and features of this system 120 are substantially similar to the corresponding components and features of the systems 10, 80 discussed above except as expressly discussed below. In this implementation, the disk 122 has twelve cameras 124 attached thereto. An alternative disk 130 is depicted in FIG. 5B, in which the disk 130 has eight cameras 132. Alternatively, any non-rotating disk embodiment can have any number of cameras ranging from two to 24. In a further alternative, the disk can have any number of cameras. The system 120 in this implementation has the same or similar height adjustment components and/or mechanisms as discussed above such that the disk 122 (and all the cameras 124 thereon) can be moved vertically to optimize the position of the cameras 124 in relation to the target plants based on the height of those plants. According to certain embodiments, in this system 120, a computer and electronic system and/or the software therein are configured to trigger rotational image capturing in a fashion that substantially replicates electronically the end effect of physically rotating cameras. In other words, such implementations use electronic rotation order instead of mechanical motion. In some implementations, the rotational image capturing can be used in situations that require higher ground speed of the system 120 or other situations that require higher definition imagery. In various embodiments of this system 120, each camera 124 can capture images at a speed ranging from about 1 to about 4,000 frames per second. Alternatively, each camera's speed can range from about 1 to about 2000 fps.

In contrast to known plant scanning vehicles, which typically have a single stationary camera that can capture only one angle of each plant, the one or more rotating (or stationary and “electronically rotating”) and height adjustable cameras of the various system embodiments herein can capture far more information far more accurately. In one example, the rotating camera(s) (including the multiple stationary cameras using electronic rotation order) can capture target plant and/or soil characteristics with 85-90% accuracy. In contrast, the X Company vehicle has a single fixed camera per row, which can likely detect disease(s) on the plants with something closer to 10-20% accuracy.

In a simplistic analogy, the difference between the current system embodiments and the known plant scanning field vehicles is the same as the difference between a CT scanner and an X-ray. The known vehicles are like an X-ray machine—they capture only one image of one angle of the target. In contrast, the various system implementations herein are more like a CT scanner—they capture multiple images of the target from multiple angles. The results are substantially different and far more accurate as a result.

FIG. 6 is a block diagram illustrating a more detailed example of a computing device configured to perform the techniques described herein. Computing device 210 of FIG. 6 is described below as an example of a computing device with processors configured to execute the software of this disclosure, as described above. FIG. 6 illustrates only one particular example of computing device 210, and many other examples of computing devices 210 may be used in other instances and may include a subset of the components included in exemplary computing device 210 or may include additional components not shown in FIG. 6.

Computing device 210 may be any computer with the processing power required to adequately execute the techniques described herein. For instance, computing device 210 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

As shown in the example of FIG. 6, computing device 210 includes user interface components (UIC) 212, one or more processors 240, one or more communication units 242, one or more input components 244, one or more output components 246, and one or more storage components 248. UIC 212 includes display component 202 and presence-sensitive input component 204. Storage components 248 of computing device 210 include analysis module 220, database 224, and rules data store 226.

One or more processors 240 may implement functionality and/or execute instructions associated with computing device 210 to analyze images to determine various points of interest including, for instance, infected plants, type of infection, stage the infection, location origin, and spread area on map. That is, processors 240 may implement functionality and/or execute instructions associated with computing device 210 to receive images from a plant scanning and image capturing system, such as system 10 of FIG. 1, save those images to database 224, and analyze those images according to rules data store 226.

Examples of processors 240 include any combination of application processors, display controllers, auxiliary processors, one or more sensor hubs, and any other hardware configured to function as a processor, a processing unit, or a processing device, including dedicated graphical processing units (GPUs). Module 220 may be operable by processors 240 to perform various actions, operations, or functions of computing device 210. For example, processors 240 of computing device 210 may retrieve and execute instructions stored by storage components 248 that cause processors 240 to perform the operations described with respect to module 220. The instructions, when executed by processors 240, may cause computing device 210 to receive images from a plant scanning and image capturing system, such as system 10 of FIG. 1, save those images to database 224, and analyze those images according to rules data store 226.

Analysis module 220 may execute locally (e.g., at processors 240) to provide functions associated with performing image analysis on images received from plant scanning and image capturing systems. In some examples, UI module 220 may act as an interface to a remote service accessible to computing device 210. For example, UI module 220 may be an interface or application programming interface (API) to a remote server that analyzes images to determine various points of interest including, for instance, infected plants, type of infection, stage the infection, location origin, and spread area on map.

One or more storage components 248 within computing device 210 may store information for processing during operation of computing device 210 (e.g., computing device 210 may store data accessed by module 220 during execution at computing device 210). In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with module 220, database 224 and rules data store 226. Storage components 248 may include a memory configured to store data or other information associated with modules module 220, database 224 and rules data store 226.

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices via one or more wired and/or wireless networks by transmitting and/or receiving network signals on one or more networks. Examples of communication units 242 include a network interface card (e.g., such as an Ethernet card), an optical transceiver, a radio frequency transceiver, a GPS receiver, a radio-frequency identification (RFID) transceiver, a near-field communication (NFC) transceiver, or any other type of device that can send and/or receive information. Other examples of communication units 242 may include short wave radios, cellular data radios, wireless network radios, as well as universal serial bus (USB) controllers.

One or more input components 244 of computing device 210 may receive input. Examples of input are tactile, audio, and video input. Input components 244 of computing device 210, in one example, include a presence-sensitive input device (e.g., a touch sensitive screen, a PSD), mouse, keyboard, voice responsive system, camera, microphone or any other type of device for detecting input from a human or machine. In some examples, input components 244 may include one or more sensor components (e.g., sensors 252). Sensors 252 may include one or more biometric sensors (e.g., fingerprint sensors, retina scanners, vocal input sensors/microphones, facial recognition sensors, cameras), one or more location sensors (e.g., GPS components, Wi-Fi components, cellular components), one or more temperature sensors, one or more movement sensors (e.g., accelerometers, gyros), one or more pressure sensors (e.g., barometer), one or more ambient light sensors, one or more sensors as described elsewhere herein with respect to system 10 or any other embodiment disclosed or contemplated herein, and one or more other sensors (e.g., infrared proximity sensor, hygrometer sensor, and the like). Other sensors, to name a few other non-limiting examples, may include a radar sensor, a lidar sensor, a sonar sensor, a heart rate sensor, magnetometer, glucose sensor, olfactory sensor, compass sensor, or a step counter sensor.

One or more output components 246 of computing device 210 may generate output in a selected modality. Examples of modalities may include a tactile notification, audible notification, visual notification, machine generated voice notification, or other modalities. Output components 246 of computing device 210, in one example, include a presence-sensitive display, a sound card, a video graphics adapter card, a speaker, a cathode ray tube (CRT) monitor, a liquid crystal display (LCD), a light emitting diode (LED) display, an organic LED (OLED) display, a virtual/augmented/extended reality (VR/AR/XR) system, a three-dimensional display, or any other type of device for generating output to a human or machine in a selected modality.

UIC 212 of computing device 210 may include display component 202 and presence-sensitive input component 204. Display component 202 may be a screen, such as any of the displays or systems described with respect to output components 246, at which information (e.g., a visual indication) is displayed by UIC 212 while presence-sensitive input component 204 may detect an object at and/or near display component 202.

While illustrated as an internal component of computing device 210, UIC 212 may also represent an external component that shares a data path with computing device 210 for transmitting and/or receiving input and output. For instance, in one example, UIC 212 represents a built-in component of computing device 210 located within and physically connected to the external packaging of computing device 210 (e.g., a screen on a mobile phone). In another example, UIC 212 represents an external component of computing device 210 located outside and physically separated from the packaging or housing of computing device 210 (e.g., a monitor, a projector, etc. that shares a wired and/or wireless data path with computing device 210).

UIC 212 of computing device 210 may detect two-dimensional and/or three-dimensional gestures as input from a user of computing device 210. For instance, a sensor of UIC 212 may detect a user's movement (e.g., moving a hand, an arm, a pen, a stylus, a tactile object, etc.) within a threshold distance of the sensor of UIC 212. UIC 212 may determine a two or three-dimensional vector representation of the movement and correlate the vector representation to a gesture input (e.g., a hand-wave, a pinch, a clap, a pen stroke, etc.) that has multiple dimensions. In other words, UIC 212 can detect a multi-dimension gesture without requiring the user to gesture at or near a screen or surface at which UIC 212 outputs information for display. Instead, UIC 212 can detect a multi-dimensional gesture performed at or near a sensor which may or may not be located near the screen or surface at which UIC 212 outputs information for display.

In accordance with the techniques described herein, analysis module 220 may receive images taken by cameras 22 of system 10. When received, analysis module 220 may save these images in database 224, which may be either a local database or a network or cloud database. Analysis module 220 may receive the images via communication units 242 via wireless transmission (e.g., in instances where computing device 210 is physically separate from system 10 or not connected by a wired connection) or via a physical connection (e.g., in instances where computing device 210 is physically integrated into system 10, such as by being included in mechanism 32, or when computing device 210 has a wired connection to system 10).

Rules data store 226 may include the models used by analysis module 220 for analyzing the images stored in database 224. More specifically, the rules data store 226 can perform standard segmentation processes on the images to identify characteristics of interest. For instance, in certain specific examples, rules data store 226 may store deep 3D models. Analysis module 220 may utilize such deep 3D models to examine the images and segment the spots that contain the one or more points of interest from the rest of the images. Analysis module 220 may process the images separately or on a point cloud made from the images and processed with deep 3D models.

Analysis module 220 may also receive other information from system 10 to perform the analysis described throughout this disclosure. For instance, analysis module 220 may receive information related to a speed of various portions of system 10 or position information for system 10 at the time each image is captured.

Analysis module 220 may perform this analysis to, for instance, detect any plant diseases in a large field of crops. For instance, analysis module 220 may identify specific diseases and further pinpoint to the specific location in the field where the images were captured as a result of the GPS capabilities of the system. Alternatively, in certain embodiments, for larger fields or those situations in which time is critical, analysis module 220 may perform sample information gathering from specific, disease-susceptible areas of the field, rather than the entire field. In this situation, any disease detection can be used to direct the system to perform a more focused search of the area where the disease was detected or, alternatively, the disease detection information can be used to treat the diseased area or take further steps without further searching.

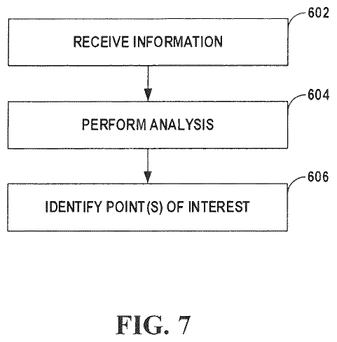

FIG. 7 is a flow chart illustrating an example mode of operation. The techniques of FIG. 7 may be performed by one or more processors of a computing device, such as computing device 210 illustrated in FIG. 6. For purposes of illustration only, the techniques of FIG. 7 are described within the context of computing device 210 of FIG. 6, although computing devices having configurations different than that of computing device 210 may perform the techniques of FIG. 7.

In accordance with the techniques of this disclosure, analysis module 220 may receive information from a plant scanning and image capturing system, such as system 10 of FIG. 1 (602). The information may include images, GPS information, and/or speed information. Analysis module 220 may perform an analysis on the information, such as by using deep 3D models (604). Based on this analysis, analysis module 220 may identify one or more points of interest based on the information, such as infected plants, type of infection, stage the infection, location origin, and spread area on a map.

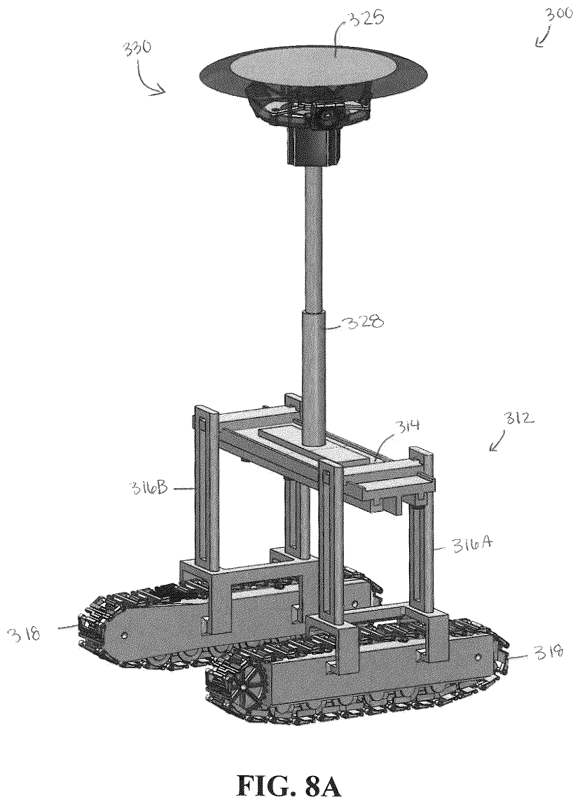

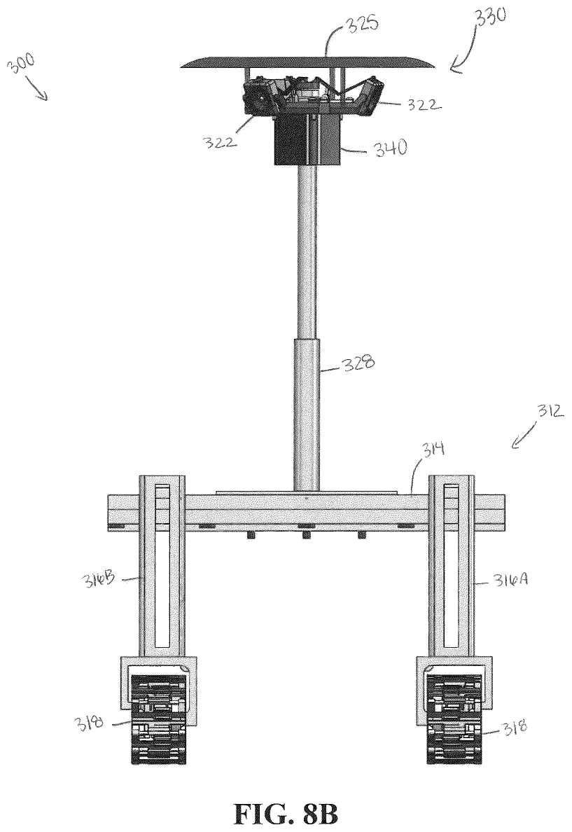

The various plant scanning and image capturing systems disclosed or contemplated herein can be configured for use with a variety of vehicles or prime movers. For example, FIGS. 8A and 8B show another exemplary embodiment of a ground-based plant scanning and image capturing system 300. As best shown in FIG. 8A, the system 300 can include a mobile base or frame 212 with a rotatable imaging (or “camera”) assembly 330 attached to the base 212 via a vertical rod 328. The mobile base 312 has a horizontal bar 314, two support frames 316A, 316B disposed at each end of the horizontal bar 314, and two continuous tracks 318 rotatably attached to the two support frames 316A, 316B as shown that can be used to allow the system 300 to move across the ground in a target area, such as a crop field. In the embodiment as shown, the vertical rod 328 can be coupled to the horizontal bar 314 at approximately the center of the bar 314. In some embodiments, the vertical rod 328 have a length of about 10 inches to about 180 inches. In other embodiments, the vertical rod 328 can have a length of 100 inches.

FIG. 8B shows a front view of the system 300 of FIG. 8A. The camera assembly 330 can include at least one camera 322 shielded by a cover 325. In this specific implementation, the assembly 330 has three cameras 322. As discussed in additional detail below, each camera 322 is disposed on the outer perimeter of the assembly 330 with the imaging lens of each camera 322 aimed outward to capture images of areas surrounding the system 300. An actuator cover (or “housing”) 340 houses at least one actuator or motor (as discussed in more detail below) configured to cause both rotational movement of the camera assembly 330 (as will be described in detail below) to provide for a panning functionality for the cameras 322 and linear movement of specific portions of the assembly 330 (as will also be described in detail below) to provide for a tilting functionality for the cameras 322. Rotation of the camera assembly 330 (panning) and linear movement of portions of the assembly (tilting) allows the cameras 322 to capture images of the area surrounding the system 300 from various views and/or angles. For the panning functionality, the camera assembly 330 can be configured to rotate 360 degrees about the vertical rod 328, thereby making it possible for the cameras 322 to capture 360 degree views of a location. The cover 325 can protect the cameras 322 from various weather elements such as wind or rain, and reduce glare in the images captured by the cameras 322, thereby providing clearer and more accurate images of a location.

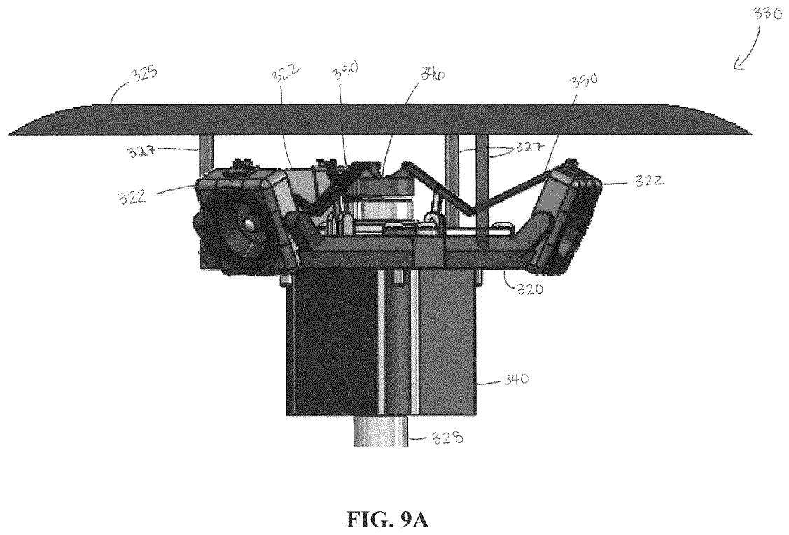

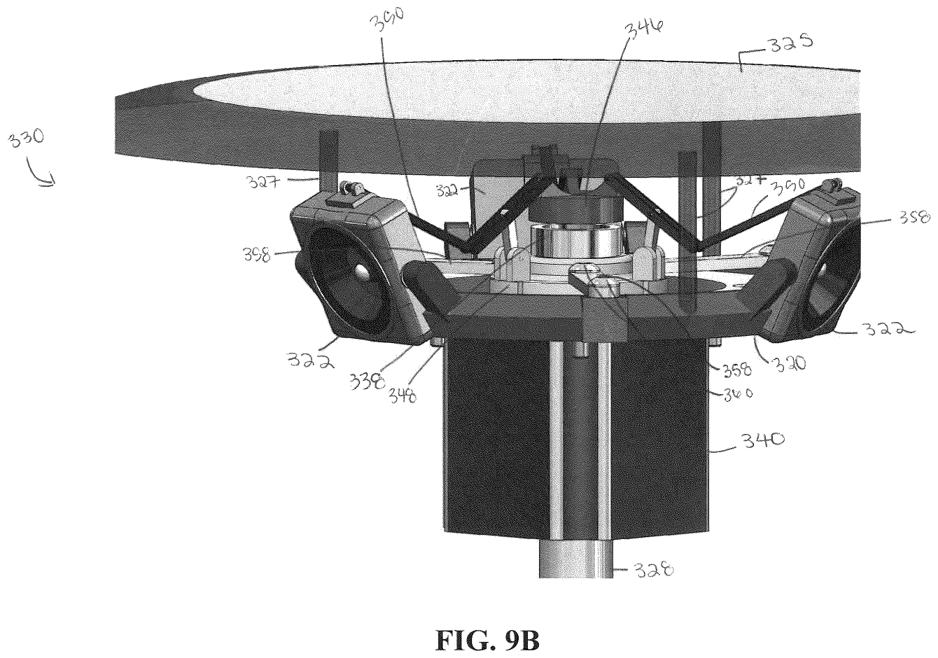

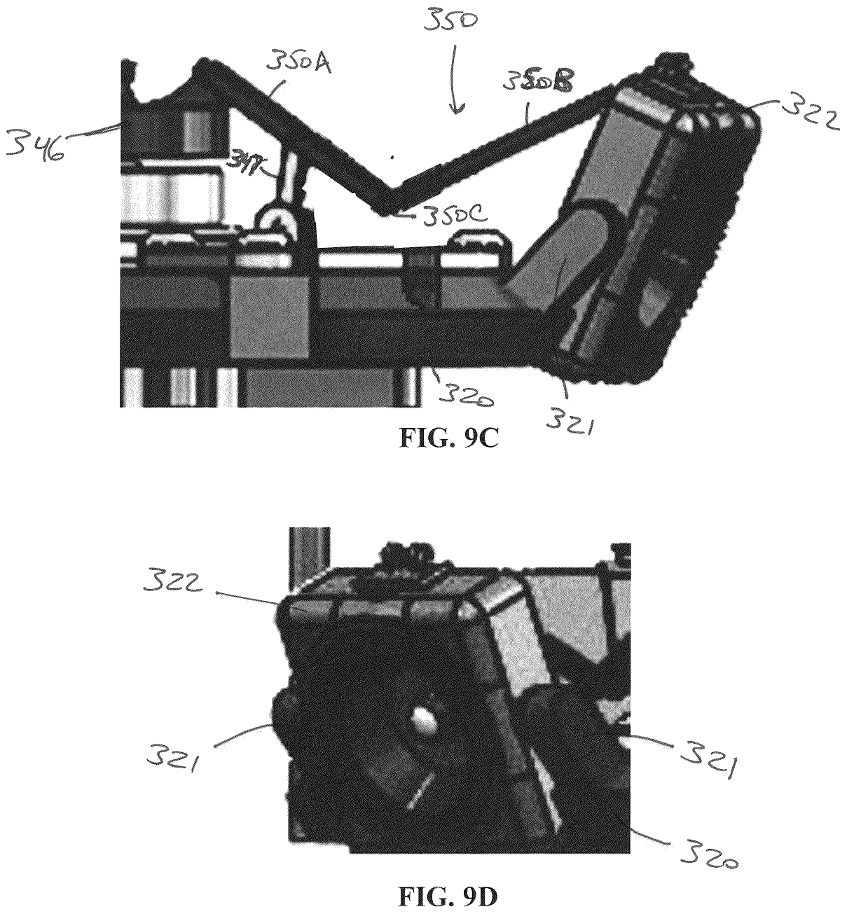

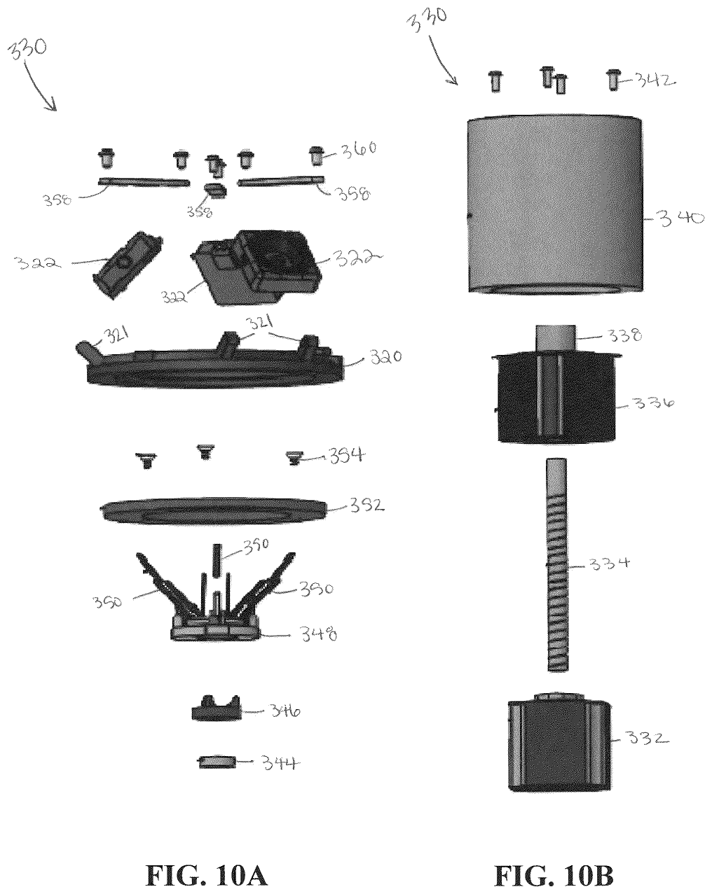

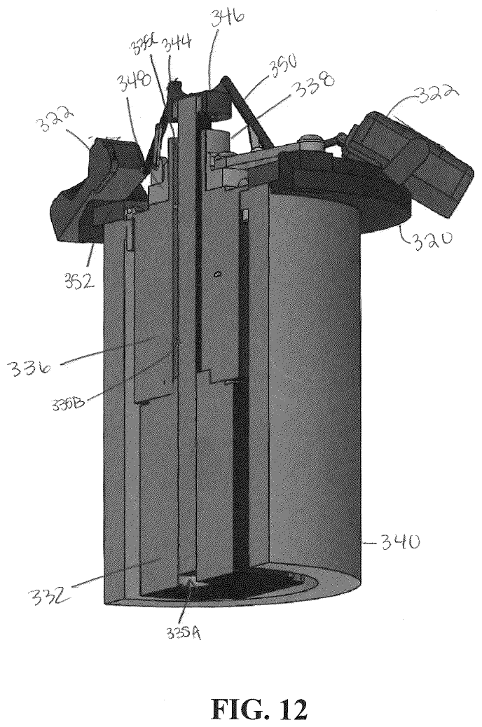

FIGS. 9A-12 show the various components of the camera assembly 330, according to one implementation, including the two separate actuation assemblies: the rotation (panning) actuation assembly and the linear (tilting) actuation assembly. The rotation actuation assembly is made up of the rotation actuator 336 (as best shown in FIGS. 10B, 11, and 12), the drive tube 338 (as best shown in FIGS. 10B and 12) attached to the actuator 336, the rotatable drive collar (or “structure”) 348 (best shown in FIGS. 9B, 10B, and 12) attached to the drive tube 338, and the rotatable frame 320 (as best shown in FIGS. 9A-B, 10A, 11, and 12) attached to the drive collar 348. The linear actuation assembly is made up of the linear actuator 332 (as best shown in FIGS. 10B, 11, and 12), the drive rod 334 attached to the actuator 332 (as best shown in FIGS. 10B and 12), the linear drive body (or “cap”) 346 (as best shown in FIGS. 9A-B, 10A, and 12) attached to the drive rod 334, and the camera tilt arms 350 (as best shown in FIGS. 9A-9C, 10A, and 12) attached to the drive cap 346.

According to the exemplary implementation as shown, the camera assembly 330 of FIGS. 9A-9D includes three cameras 322 mounted on the rotating frame 320 such that the cameras 322 can rotate with the frame 320 when the frame 320 is rotated and further can rotate up and down (tilt) in relation to the frame 320. That is, as best shown in FIGS. 9C and 9D, each camera 322 can be rotatably mounted to the frame 320 via two attachment arms (or “structures”) 321 on the frame 320 such that the camera 322 is attached to the frame 320 while allowing the cameras 322 to tilt (pivot in relation to the attachment arms 321 around an axis parallel to the diameter of the frame 320). More specifically, each camera 320 can be pivotably attached to a pair of attachment arms 321 that are spaced apart from each other such that camera is disposed between the pair and can be rotatably coupled on one side of the camera 320 to one of the two arms 321 and on the other side to the other arm 321. Alternatively, any known attachment structures or mechanisms can be provided to rotatably attach the cameras 322 to the rotatable frame 320 such that each camera 322 can rotate in relation to the frame 320 as described herein.

As best shown in FIGS. 9A-C, in addition to being rotatably coupled to the frame 320 as described above, each camera 322 is also rotatably coupled to a camera tilt arm 350 such that the camera tilt arm 350 can urge the camera 322 to tilt (rotate in relation to the attachment arms 321 as described above). More specifically, the rotatable camera assembly 330 has three camera tilt arms 350, which each attached to one of the cameras 322. As best shown in FIG. 9C, each tilt arm 350 has a first link 350A and a second link 350B that is rotatably coupled to the first link 350A at a rotatable joint (or “elbow joint”) 350C. The first link 350A is rotatably coupled at a first end to the linear drive body 346 and at a second end to the elbow joint 350C. Further, the first link 350A is rotatably coupled at a point along the length of the first link 350A to the drive collar 348 via a connection arm 347. The second link 350B is rotatably coupled at a first end to the elbow joint 350C and at a second end to the camera 322. As a result, when the linear actuator 332 is actuated to urge the rod 334 upward such that the drive body 346 is urged upward, the first end of the first link 350A is driven upward, which causes the second end to be driven downward (as a result of the first link 350A pivoting at the connection arm 347). This causes the first end of the second link 350B to move downward, thereby causing the camera 322 to rotate in relation to the arms 321 such that the top of the camera is pulled inward (toward the drive body 346), thereby tilting the camera up. In contrast, when the actuator 332 is actuated to urge the rod 334 downward, the drive body is urged downward, the first end of the first link 350A is driven downward, the second end of the first link 350A is drive upward, and thus the top of the camera 322 is urged outward, thereby tilting the camera down.

As best shown in FIGS. 10A-12, one exemplary embodiment of the actuation assemblies (as discussed above) of the rotatable camera assembly 330 has the following specific configuration. The drive collar 348 is disposed within the camera frame 320 such that the rotational axis of the drive collar 348 is substantially coaxial with the rotational axis of the frame 320. Further, the drive collar 348 is not only rotatably coupled to the camera tilt arms 350 as shown (and as discussed above), but is also attached to the camera frame 320 via three frame connectors 358, each of which is attached at one end to the drive collar 348 and at the other end to the frame 320. Further, the connectors 358 in this implementation are fastened using fasteners 360 (such as screws and/or bolts). Alternatively, any known fasteners or fastening mechanisms. Thus, the frame 320 is rotationally constrained to the drive collar 348 such that rotation of the drive collar 348 causes rotation of the frame 320. Alternatively, the assembly 330 can have two, four, five, or any number of frame connectors 358, or, in a further alternatively, can have any other known attachment component or mechanism for coupling the camera frame 320 to the drive collar 348.

Further, in certain implementations, a frame platform or bearing 352 can be provided such that the platform 352 is attached to the motor housing 340 and the camera frame 320 can be rotatably disposed on the platform 352. The platform 352 can be attached to the housing 340 via fasteners 354 similar to the fasteners 360 discussed above. Alternatively, the platform 352 can be attached to the camera frame 320 such that the frame 320 and platform 352 rotate in relation to the motor housing 340.

Additionally, the linear drive cap 346 is not only coupled to the camera tilt arms 350, but is also linearly coupled to the linear drive rod 334. More specifically, the linear drive cap 346 is coupled to the linear drive rod 334 such that when the rod 334 is actuated to move up and/or down, the drive cap 346 is urged to move up and/or down along with the rod 334. However, the cap 346 must also be rotatable in relation to the drive rod 334, because the cap 346 is also coupled to the camera tilt arms 350 as discussed above. Thus, when the drive collar 348 is actuated to rotate such that the camera frame 320 and cameras 322 are also actuated to rotate, the tilt arms 350 will rotate as well, thereby causing the drive cap 346 to rotate. Thus, the cap 346 is coupled to the drive rod 334 such that it can be urged linearly by the drive rod 334 while also allowing for it to rotate in relation to the rod 334. In one specific embodiment, a bearing 344 is provided that is disposed within the drive cap 346 and in contact with the drive rod 334 to facilitate rotation of the cap 346 in relation to the rod 334.

Thus, the combination of the rotation actuation assembly (as described above) and the linear actuation assembly (as also described above) make it possible for the rotatable camera assembly 330 to provide cameras 322 that can both pan (rotate with the camera frame 320) due to the rotation actuation assembly (as described above) and tilt (rotate in relation to the camera frame 320 around an axis transverse to the rotational axis of the frame 320) due to the linear actuation assembly (as described above).

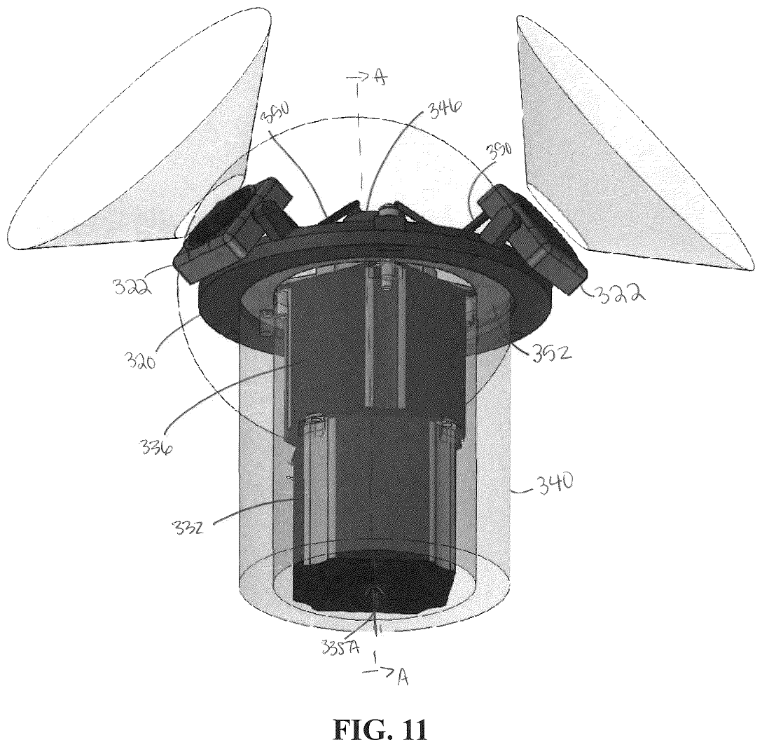

As best shown in FIGS. 11 and 12, according to one embodiment, the linear actuator 332 and the rotation actuator 336 are disposed within the actuator housing 340 as shown. As discussed above, the linear drive rod 334 is disposed within and operably coupled to the linear actuator 332 such that actuation of the actuator 332 causes the linear drive rod 334 to move linearly up and/or down. In one specific embodiment as best shown with reference to FIGS. 10B and 12, the linear drive rod 334 is disposed through a lumen 335A defined through the linear actuator 332 and has external threads (or other external features) that mateably couple with matching threads (or other matching features) on the inner surface of the lumen 335A. Thus, the actuator 332 can cause the inner surface of the lumen 335A to rotate such that the rotation is translated into linear movement of the drive rod 334 via the threads. Alternatively, the actuator 332 and rod 334 can have any configuration or mechanisms that allow for the actuator 332 to cause the rod 334 to move linearly as described herein.

In addition, according to the specific implementation as shown, the rotation actuator 336 is disposed above the linear actuator 332 such that the linear drive rod 334 is disposed through the rotation actuator 336 and the drive tube 338. More specifically, the rotation actuator 336 also has a lumen 335B defined through the actuator 336 and the drive tube 338 has a lumen 335C such that the rod 334 can pass through the lumens 335B, 335C and thus can be coupled to the drive cap 346 as described above. Further, the drive tube 338 is rotationally constrained to the actuator 336 such that actuation of the actuator 336 causes rotation of the drive tube 338. Because the drive tube 338 is attached to the drive collar 348 as discussed above, rotation of the drive tube 338 causes rotation of the drive collar 348.

In some embodiments, the linear actuator 332 is a motor such as a LA42 Non-Captive Linear Actuator—Nema 17, which is commercially available from Nanotec (https://us.nanotec.com/). Other similar motors can include stepper motors from Dings' Motion and Helix. Alternatively, any known motors or actuators for use in such devices can be used. Further, according to some implementations, the rotation actuator 336 can be a motor such as a hollow shaft motor commercially available from Nanotec. Other similar motors can include hollow shaft motors from Otostepper. Alternatively, any known motors or actuators for use in such devices can be used.

In alternative embodiments, the rotatable camera assembly 330 can have one camera, two cameras, four cameras, five cameras, six cameras, or any number of cameras disposed around the perimeter thereof (and associated actuation assemblies) in a fashion similar to that described above for the exemplary embodiment have three cameras 322 as shown.

The combination of pan and tilt movement of the cameras 322 can allow the cameras 322 to capture additional images and views of a location in any direction. By broadening the range of capturable locations, the system 300 can assist in monitoring crops to determine soil quality, nutrient deficiencies, disease, and/or pests at a location with improved accuracy.

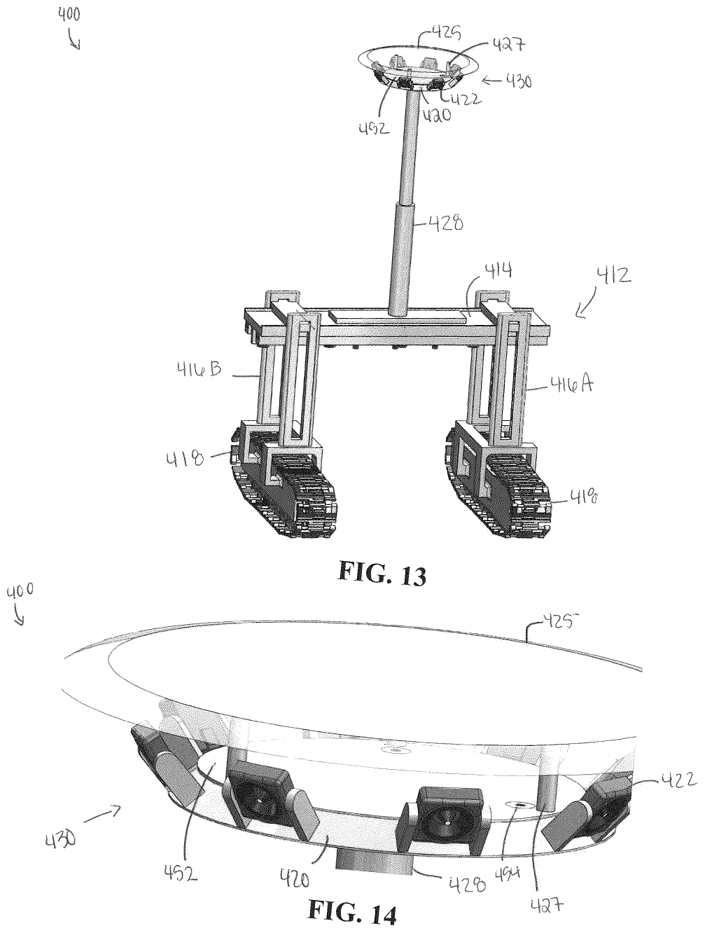

FIG. 13 shows an exemplary embodiment of yet another ground-based plant scanning and image capturing system 400. The system 400 has a camera assembly 430, a frame 412, horizontal bar 414, vertical support frames 416A, 416B, and tracks 418. In one embodiment, the frame 412 can be substantially similar to the system 300 of FIGS. 8A-8B.

Some embodiments of the camera assembly 430 can include eight cameras 422 as shown. In other embodiments, the camera assembly 430 can have two, three, four, five six, seven, nine, ten, or up to more than one-hundred cameras. The camera assembly 430 can be attached to the system 400 via the vertical rod 428. In this specific implementation, unlike the system 300 discussed above, the camera assembly 430 is not rotatable. Thus, the system 400 has no rotation actuator.

FIG. 14 shows one embodiment of the camera assembly 430 of the system 400. The cameras 422 are disposed on an outer frame 420, which is attached to an inner frame 452 using a plurality of fasteners 454. Like the system 300 shown in FIG. 8A, the inner frame 452 can include a plurality of columns 427 supporting a cover 425 configured to shield the cameras 422 from the environment and/or weather. Both the inner frame 452 and outer frame 420 can be generally the same shape. In some embodiments, both frames 420, 452 can be generally circular. However, the frames 420, 452 can be any shape allowing the disposition of cameras 422 thereon wherein the cameras are able to capture a 360 degree view of a location.

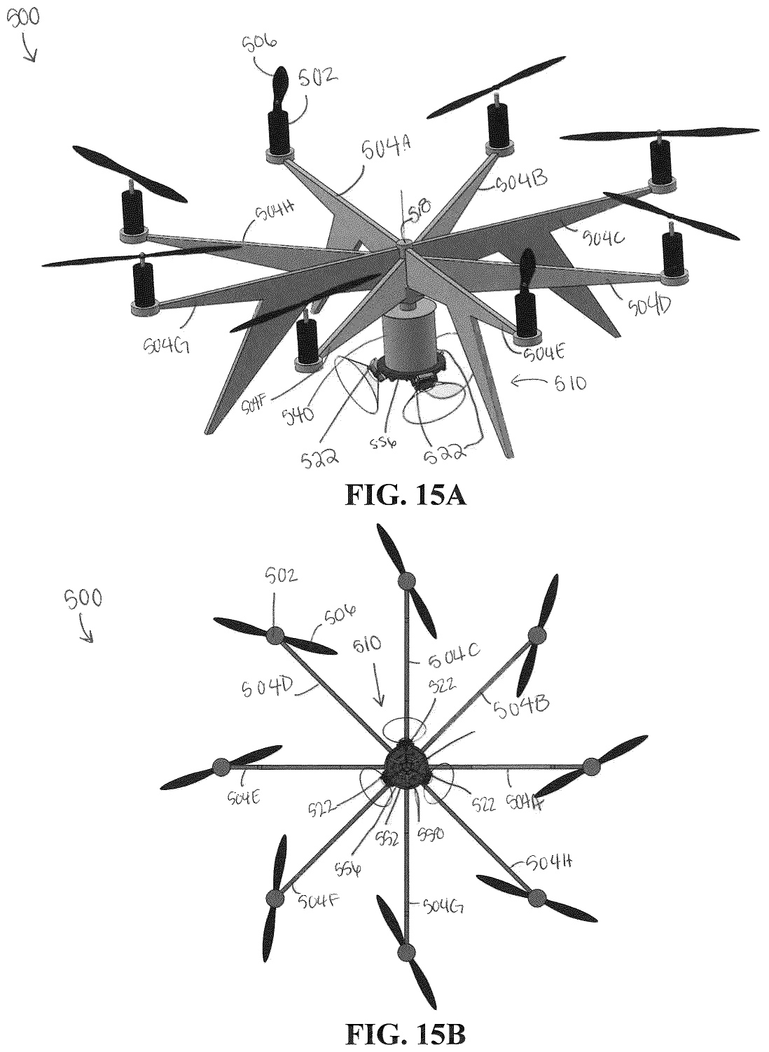

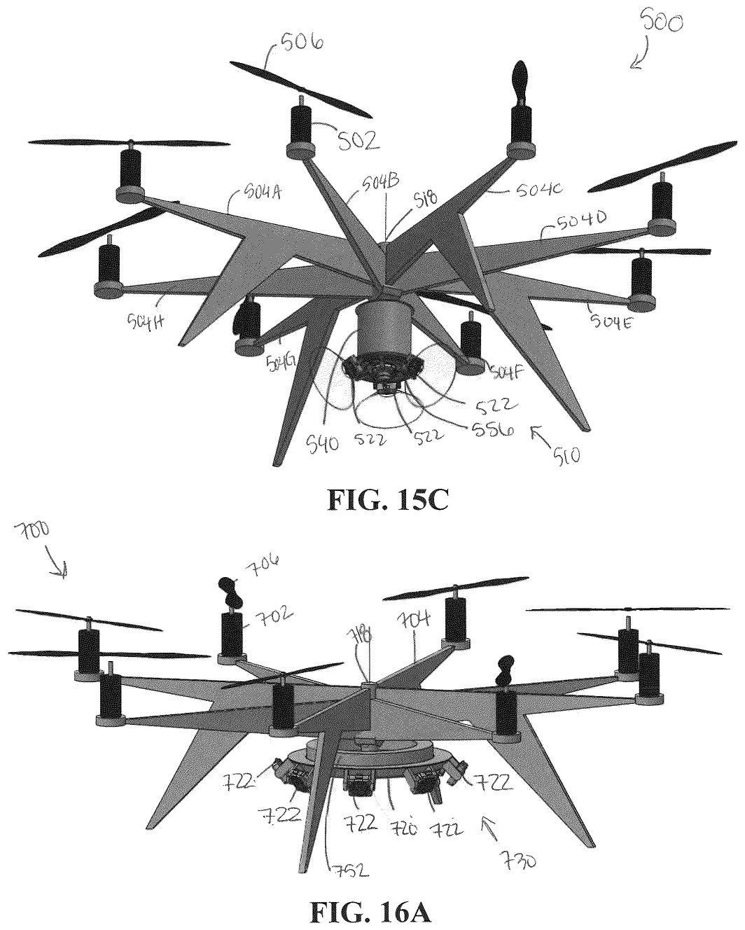

FIGS. 15A-15C show another exemplary embodiment of a plant scanning and image capturing system 500, which in this case is a flying system (or “drone”) 500. In this embodiment, the drone 500 has a camera assembly 510 attached thereto. While the flying component of the system 500 can be configured according to any known drone, the exemplary drone 500 as shown has eight propellers 506, each operably connected to a motor 502. Each motor 502 can be disposed on a drone frame member 504 such that the system 500 has eight frame members 504A-H. The drone frame members 504A-504H can be radially disposed around a vertical rod 518 coupled to the camera assembly 510. The camera assembly 510 can be used in combination with any drone configurable for use with a camera assembly 510.

According to one implementation, the camera assembly 510 is substantially similar to the corresponding components and features of the camera assembly 330 as discussed above, except as expressly set forth below. That is, the actuator housing 540 can include a linear actuator (not pictured) and a rotation actuator (not pictured) causing rotating and angular movement of the cameras 522. The cameras 522 can be mounted on the rotatable frame 556 operably connected to the actuators (not pictured) of the camera assembly 510. Thus, while the drone 500 is in operation, the camera assembly 510 can rotate the rotatable frame 556 and angularly adjust the cameras 522.

Thus, the cameras 522 can be configured to capture a 360 degree view of an area below and surrounding the drone 500. As best shown in FIGS. 15A and 15C, the camera assembly 510 of the drone 500 can be disposed below the frame 504 when the drone 500 is in use. This positioning prevents obstruction of the cameras 522 by the frame 504.

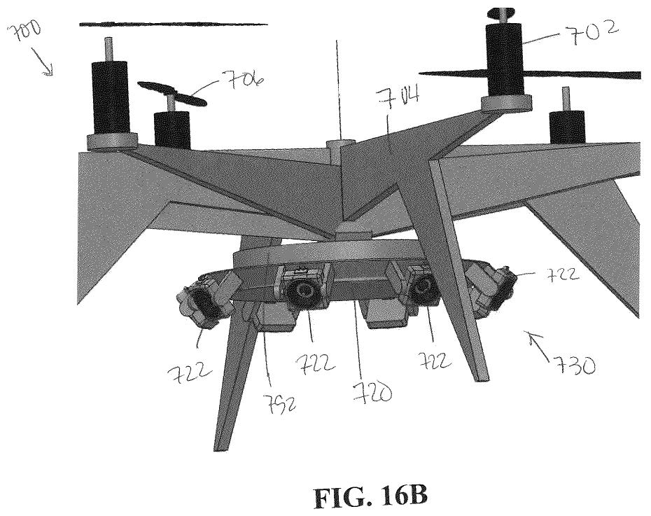

FIG. 16A and FIG. 16B show an alternative flying plant scanning and image capturing system (or “drone”) 700. The various components and features of this camera assembly 730 are substantially similar to the corresponding components and features of the camera assembly 430 discussed above except as expressly discussed below. FIG. 16A shows the camera assembly 730 including cameras 722, an inner frame 752 and an outer frame 720. The camera assembly 730 can be disposed below the drone frame 704, motors 702, and propellers 706 such that the frame 704 does not block the field of vision of the cameras 722. The inner frame 752 can be coupled to the vertical rod 718 of the drone 700, thereby attaching the camera assembly 730 to the drone 700. The outer frame 720 can be attached to the inner frame 752. The camera(s) 722 can be attached to the outer frame 720. In some embodiments, the cameras can be radially disposed around the outer frame 720. In some implementations, this camera assembly 730 is not rotatable.

The camera assemblies 330, 430, 510, 730 are each shown in use with vehicular systems or prime movers such as drones 500, 700 or vehicles/prime movers using a track 300, 400. However, it should be noted that the various camera assemblies 330, 430, 510, 730 disclosed or contemplated herein can each be used in combination with any known ground-based or flying vehicle. This includes, but is not limited to, prime movers including those with wheels, flying prime movers, or farm equipment to which the assemblies 330, 430, 510, 730 can be attached. Each assembly 330, 430, 510, 730 can be configured for use with any structure that could allow the cameras to capture images at a location, including structures operably coupleable with vehicles to facilitate the movement of the assemblies 330, 430, 510, 730.

In one specific use example, any of the embodiments herein can be used to monitor multiple different plant lines in plant-breeding situations. More specifically, a plant-breeding entity (such as a company, research institution, or university, for example) will typically plant multiple different plant lines in the same field and monitor the different characteristics in those different lines as the plants emerge from the soil and grow. This allows the entity to identify the lines with the best and most desirable characteristics. The manual process for this in-field plant monitoring is extremely labor intensive and requires multiple people to examine multiple characteristics of multiple plants on a regular—typically daily—basis. Known plant scanning vehicles cannot capture or monitor the target characteristics in sufficient detail or with sufficient accuracy. In contrast, the various systems herein can operate to capture the desired information with regularity, specificity, and accuracy. More specifically, one or more of the system implementations herein can be manually or autonomously driven through the field on a daily basis to capture the desired plant characteristics using the system features described herein. The one or more rotating cameras with height adjustment and targeted capture of specific characteristics make it possible to successfully replace the multiple expert personnel typically required for the same activity.

In another specific use example, any of the embodiments herein can be used to detect any plant diseases in a large field of crops. For example, in one embodiment, one of the system embodiments herein passes through the field with appropriate cameras for detecting plant disease and gathers the detailed images for processing. Any specific diseases can be identified by the system and further can be pinpointed to the specific location in the field where the images were captured as a result of the GPS capabilities of the system. Alternatively, in certain embodiments, for larger fields or those situations in which time is critical, the system can be programmed or otherwise controlled to perform sample information gathering from specific, disease-susceptible areas of the field, rather than the entire field. In this situation, any disease detection can be used to direct the system to perform a more focused search of the area where the disease was detected or, alternatively, the disease detection information can be used to treat the diseased area or take further steps without further searching.

While the various systems described above are separate implementations, any of the individual components, mechanisms, or devices, and related features and functionality, within the various system embodiments described in detail above can be incorporated into any of the other system embodiments herein.

The terms “about” and “substantially,” as used herein, refers to variation that can occur (including in numerical quantity or structure), for example, through typical measuring techniques and equipment, with respect to any quantifiable variable, including, but not limited to, mass, volume, time, distance, wave length, frequency, voltage, current, and electromagnetic field. Further, there is certain inadvertent error and variation in the real world that is likely through differences in the manufacture, source, or precision of the components used to make the various components or carry out the methods and the like. The terms “about” and “substantially” also encompass these variations. The term “about” and “substantially” can include any variation of 5% or 10%, or any amount—including any integer—between 0% and 10%. Further, whether or not modified by the term “about” or “substantially,” the claims include equivalents to the quantities or amounts.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾ This applies regardless of the breadth of the range. Although the various embodiments have been described with reference to preferred implementations, persons skilled in the art will recognize that changes may be made in form and detail without departing from the spirit and scope thereof.

While multiple embodiments are disclosed, still other embodiments will become apparent to those skilled in the art from the following detailed description, which shows and describes illustrative embodiments. As will be realized, the various implementations are capable of modifications in various obvious aspects, all without departing from the spirit and scope thereof. Accordingly, the drawings and detailed description are to be regarded as illustrative in nature and not restrictive.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Although the various embodiments have been described with reference to preferred implementations, persons skilled in the art will recognize that changes may be made in form and detail without departing from the spirit and scope thereof.

What is claimed is:

1. A system for monitoring plant or soil characteristics in a crop field, the system comprising:
(a) a prime mover comprising a base;
(b) a camera frame operably coupled to the base, the camera frame comprising:
(i) a central frame;
(ii) a rotatable frame rotatably attached to the central frame; and
(iii) at least one camera attached to the rotatable frame.

2. The system of claim 1, wherein the at least one camera is rotatable in relation to the prime mover.

3. The system of claim 2, wherein the camera frame is rotatable in relation to the prime mover.

4. The system of claim 1, wherein the camera frame further comprises a rotation actuator.

5. The system of claim 1, wherein the camera frame is a disk or an arm.

6. The system of claim 1, wherein the at least one camera is angularly movable.

7. The system of claim 6, wherein the camera frame comprises an angular adjustment actuator configured to angularly move the at least one camera.

8. The system of claim 1, further comprising a height adjustment mechanism coupled to the base and the camera frame.

9. The system of claim 8, wherein the height adjustment mechanism further comprises an actuator and a height sensor, wherein the height sensor is configured to track a position of the camera frame, and wherein the actuator is configured to change a height of the camera frame.

10. The system of claim 1, wherein the prime mover comprises a structure selected from a group consisting of a drone, at least four wheels, and at least one track.

11. The system of claim 1, wherein the at least one camera is configured to rotate up to about 360 degrees about an axis.

12. A system for monitoring plant or soil characteristics in a crop field, the system comprising:
(a) a prime mover comprising at least four wheels and a horizontal bar;
(b) a height adjustment mechanism coupled to the horizontal bar; and
(c) a non-rotatable camera frame operably coupled to the height adjustment mechanism, the non-rotatable camera frame comprising at least two cameras attached to the non-rotatable camera frame.

13. The system of claim 12, wherein the non-rotatable camera frame is a disk.

14. The system of claim 12, wherein the height adjustment mechanism further comprises an actuator and a height sensor, wherein the height sensor is configured to track a position of the non-rotatable camera frame, and wherein the actuator is configured to change a height of the non-rotatable camera frame.

15. A system for monitoring plant or soil characteristics in a crop field, the system comprising:
(a) a prime mover comprising a base;
(b) a height adjustment mechanism coupled to the base comprising a height adjustment actuator and a height sensor; and
(c) at least one camera frame operably coupled to the height adjustment mechanism, the at least one camera frame comprising:
(i) a central frame;
(ii) a rotatable frame rotatably attached to the central frame;
(iii) a rotatable frame actuator configured to rotatably move the rotatable frame relative the central frame;
(iv) a rotation sensor configured to track a rotation speed of the rotatable frame; and
(v) at least one camera attached to the rotatable frame,
wherein the height sensor is configured to sense a height of the at least one camera frame and the height adjustment actuator is configured to change the height of the at least one camera frame.

16. The system of claim 15, wherein each camera comprises a downward angular position relative the rotatable frame ranging from about 30 degrees to about 60 degrees.

17. The system of claim 15, wherein the rotatable frame actuator comprises a motor gear rotatably coupled to the rotatable frame.

18. The system of claim 15, wherein the at least one camera frame is configured to rotate 360 degrees.

19. The system of claim 15, wherein the at least one camera frame can rotate from about 0.1 rpm to about 100 rpm.

20. The system of claim 15, wherein the prime mover comprises a speed wheel configured to track a ground speed of the prime mover, the speed wheel being in communication with the rotation sensor, the rotation sensor being configured to change the rotation speed in response to the ground speed.
